(19) United States
(12) Patent Application Publication
(10) Pub. No.: US 2018/0306902 A1
(43) Pub. Date: Oct. 25, 2018

(54) MIMO RADAR SYSTEM AND CALIBRATION METHOD THEREOF

(71) Applicant: QAMCOM TECHNOLOGY AB, Gothenburg (SE)

(72) Inventors: Thomas PERNSTÅL, Åsa (SE); Gary SMITH JONFORSEN, Askim (SE); Christer ANDERSSON, Gothenburg (SE)

(73) Assignee: QAMCOM TECHNOLOGY AB, Gothenburg (SE)

(21) Appl. No.: 15/769,779

(22) PCT Filed: Oct. 18, 2016
(86) PCT No.: PCT/SE2016/051005

§ 371 Date: Apr. 20, 2018

(30) Foreign Application Priority Data
Oct. 23, 2015 (SE) 1530165-8

(51) Int. Cl. G01S 7/40; G01S 13/00

(52) U.S. Cl. CPC G01S 7/40; G01S 13/003; G01S 7/4026

(57) ABSTRACT

A method of calibrating a multiple-input and multiple-output radar system is provided. The radar system includes a transmitting array and a physical receiving array. The transmitting array includes a first transmitter and a second transmitter spaced a distance away from the first transmitter. In the method, a waveform signal is transmitted firstly from the first transmitter and then from the second transmitter, such that receiving sub-apertures of the physical receiving array overlap with receiving sub-apertures of a virtual receiving array. The waveform signal is received at the physical and virtual receiving arrays. Subsequently, deviations in response between the physical receiving array and the virtual receiving array are computed. Effective positions of the first transmitter and the second transmitter are assessed, based upon the computed deviations. Setup calibrations needed for the multiple-input and multiple-output radar system are then determined, in order to reduce the computed deviations.

### TECHNICAL FIELD

The present disclosure relates to radar systems, for example to multiple-input multiple-output (MIMO) radar systems that are capable of performing on-site calibration during their manufacturing and/or installation. Moreover, the present disclosure concerns methods of calibrating on-site a multiple-input and multiple-output (MIMO) radar system, for example, during manufacturing and/or installation of the MIMO radar system. Furthermore, the present disclosure relates to a computer program product comprising a non-transitory computer-readable storage medium having computer-readable instructions stored thereon, the computer-readable instructions being executable by a computerized device comprising processing hardware to execute the aforesaid methods.

### BACKGROUND

In overview, multiple-input multiple-output (MIMO) radar systems are well known. Typically, a MIMO radar system includes a transmitting array, including a plurality of transmitters, for transmitting electromagnetic radiation towards a region of interest (ROI) and a receiving array, including a plurality of receivers, for receiving a portion of the transmitted electromagnetic radiation that is reflected back from the region of interest (ROI). On account of the transmitting array and/or the receiving array having polar characteristics having polar directions of greater gain, the MIMO radar system is capable of spatially mapping out the region of interest (ROI). Moreover, time-of-flight and Doppler frequency shift information included in the portion of the transmitted electromagnetic radiation that is reflected back from the region of interest (ROI) enables the MIMO radar system in operation to monitor one or more objects in the region of interest (ROI).

In a Chinese patent application CN 102521472 A, “Method for Constructing Thinned MIMO (Multiple Input Multiple Output) Planar Array Radar Antenna”, there is described a method of constructing a thinned MIMO planar array radar antenna, based upon a phase centre (US English: “center”) approximation principle. When all transmitting array elements simultaneously, or in turn, transmit orthogonal signals and receiving array elements simultaneously receive echo signals, a virtual planar array with uniform intervals is subjected to equivalence processing by utilizing the phase centre approximation principle. Consequently, a number of array elements required in the thinned MIMO planar array radar antenna is greatly reduced, as compared to a planar array antenna that is directly arranged and has a same size as the virtual planar array.

In a Korean patent KR 100750967 B1, “High-resolution Short Range Radar System of a Vehicle based on a Virtual Array Antenna System for Simplifying a Frequency Conversion System to Improve Receiving Characteristic with Using a Cheap Antenna” (inventors: Young Jin Park, Kwan Ho Kim, Soon Woo Lee; applicant: Korea Electro Technology Research Institute), there is described a high-resolution short range radar system of a vehicle for preventing vehicle collision and securing safe driving. The radar system includes a radar transmitting unit for transmitting a radar signal, a radar receiving unit for receiving the reflected radar signal and for outputting the reflected radar signal as a digital signal, and a signal processing unit for measuring distance, speed, and azimuth by applying digital beam forming (DBF) to the digital signal. The radar transmitting and receiving units transmit and receive the radar signal, respectively, by using an antenna array including a plurality of antenna elements. Signals provided by the antenna array are converted into those of a virtual array antenna in the signal processing unit. Spatial resolution of the radar system is increased by changing the number of antennas virtually transmitting or receiving the radar signal, through a conversion process that applies an algorithm using intervals among the antenna elements for actually transmitting or receiving the radar signal.

A research article titled “MIMO Radar Sensitivity Analysis of Antenna Position for Direction Finding” (author: Haowen Chen et al.) relates to sensitivity analysis of antenna positions. The research article has a purpose to investigate direction finding sensitivities (DFSs) with respect to antenna position uncertainties (APUs) for multiple-input multiple-output (MIMO) radar with colocated antennas. In the research article, there is provided an evaluation of effects of calibrated errors on DFS's, wherein the DFS's relative to APU's are considered from two following approaches. In a first approach, the research article describes use of a first-order sensitivity analysis for MIMO radar. The research article states that, for a given arbitrary antenna geometry, the formulas of DFS's using a maximum likelihood (ML) algorithm are developed for relatively small APU's. In addition, the formula for computing ambiguity thresholds of the ML algorithm as a function of target separation and other DF system parameters are derived for relatively large APU's. Alternatively, the DFS's are only concerned with antenna geometry, namely the virtual array manifold, being regardless of any certain DF algorithm. The research article extends Manikas's method to MIMO radar. To assess the importance of each antenna in a given MIMO radar system, the research article derives an antenna importance function (AIF) that is defined as an amount of varieties of manifold vectors from the APU's. Furthermore, to compare the robustness to APU's for mutually different antenna geometries, there is derived an overall system sensitivity (OSS) for MIMO radar systems. In a numerical example section of the research article, there are shown the previous DFS analysis results by several representative MI MO radar antenna geometries.

In a published PCT patent application WO2008/003022A2, “Calibration systems and techniques for distributed beamforming” (inventor: Patrick Mitran), there is described an apparatus including a first transmitter node that is operable to cooperate with a second transmitter node for cooperatively communicating with a receiver node. An effective channel knowledge is acquired in operation for channels between the first and second transmitter nodes and the receiver node. Transmit and receive chains of the first and second transmitter nodes are calibrated based on the effective channel knowledge.

MIMO radar systems are often used in on-vehicle collision hazard warning and/or automatic braking systems, or for monitoring hazards at busy safety-critical regions, for example, such as railway level-crossings and pedestrian crossings. Thus, it is desirable for the MIMO radar systems to be compact in size. In a MIMO radar system that is operable to transmit and receive electromagnetic radiation, for example, at a frequency (f) of substantially 77 GHz, namely having a wavelength (λ) of substantially 4 mm (λ=c/f, where ‘c’ is the speed of light in vacuum), a transmitting array of the MIMO radar system has antenna pads at a spacing of substantially X or λ/2. In practice, manufacturing errors in the antenna pads' dimensions and/or other features, for example, such as casing features, can occur, and can influence polar transmission and/or reception characteristics of the MIMO radar system.

The aforementioned manufacturing errors pose only minor calibration issues for a receiving array of the MIMO radar system. Certain other factors pose major calibration issues for the receiving array of the MIMO radar system. These factors include:
(i) mounting errors of transmitting channels of the transmitting array; the transmitting array typically has two to four transmitting channels, although other numbers of channels can also be employed, and/or
(ii) different characteristics of radio-frequency (RF) waveforms transmitted from the different transmitting channels.

In operation of a MIMO radar system, practical issues can also arise, for example partial obscuration of the channels of MIMO transmitting and receiving arrays due to debris and precipitation. Moreover, a temporal drift in characteristics of the transmitting array and/or the receiving array can arise in practice, due to ageing of component parts, corrosion, and such like.

With respect to (ii) above, it is desirable that each transmitting channel illuminates using an exactly mutually similar RF waveform; however, intentional differences in waveform amplitudes or relative phases employed for the transmitting channels are optionally employed for obtaining preferred polar transmission characteristics. In other words, the RF waveforms transmitted from the different transmitting channels should comprise a same chirp rate, namely a slope in a frequency domain, and same frequency components, wherein these frequency components have a same relative amplitude and phase. However, due to hardware deviations of the different transmitting channels, for example, such as difference in phase-lock-loop (PLL) characteristics between the transmitting channels, illumination of exactly mutually similar RF waveforms is typically not achieved.

As a consequence of the aforementioned manufacturing errors and the aforementioned mounting errors, an effective spatial location of the transmitting channels is not known. Moreover, the different characteristics of the RF waveforms also influence performance of the MIMO radar system.

### SUMMARY

The present disclosure seeks to provide an improved method of performing on-site calibration of a multiple-input and multiple-output (MIMO) radar system, for example, during manufacturing and/or installation of the MIMO radar system.

Moreover, the present disclosure seeks to provide an improved multiple-input and multiple-output (MIMO) radar system that is capable of performing on-site calibration during its manufacturing and/or installation.

According to a first aspect, there is provided a method of calibrating a multiple-input and multiple-output (MIMO) radar system, wherein the MIMO radar system includes a transmitting array and a physical receiving array, the transmitting array including at least a first transmitter and a second transmitter that is spaced a distance away from the first transmitter, characterized in that the method includes:
transmitting a waveform signal firstly from the first transmitter and then from the second transmitter such that receiving sub-apertures of the physical receiving array overlap with receiving sub-apertures of a virtual receiving array;
receiving corresponding reflections of the waveform signal at the physical receiving array and at the virtual receiving array;
computing deviations in response between the physical receiving array and the virtual receiving array;
assessing effective positions of the first transmitter and the second transmitter, based upon the computed deviations; and
determining setup calibrations needed for the MIMO radar system in order to reduce the computed deviations.

The embodiments of the present disclosure are of advantage in that use of the physical receiving array and the virtual receiving array enable the deviations to be computed and the MIMO radar system correspondingly to be adjusted to improve its technical performance.

Optionally, the method is implemented as an iterative calibration in order to reduce the computed deviations.

Optionally, the method further includes minimizing an error between the overlapping physical and virtual receiving sub-apertures. Optionally, in the method, the minimizing the error includes employing a least square fit. Optionally, the error is minimized iteratively by employing a plurality of cycles of computing the deviations.

Optionally, in the method, the waveform signal includes a linear, frequency-modulated chirp.

Optionally, in the method, the waveform signal includes a step-wise frequency-modulated chirp.

Optionally, in the method, the transmitting the waveform signal includes transmitting the waveform signal at different time slots.

Optionally, in the method, the computing the deviations includes computing waveform deviations.

Optionally, the method further includes assessing a frequency response of the virtual receiving array.

Optionally, the method is performed during manufacturing of the MIMO radar system.

Optionally, the method is performed during installation of the MIMO radar system.

According to a second aspect, there is provided a multiple-input and multiple-output (MIMO) radar system including a transmitting array, a physical receiving array and a signal processing arrangement, the transmitting array including at least a first transmitter and a second transmitter that is spaced a distance away from the first transmitter, characterized in that the MIMO radar system is configured to:
transmit a waveform signal firstly from the first transmitter and then from the second transmitter such that receiving sub-apertures of the physical receiving array overlap with receiving sub-apertures of a virtual receiving array;
receive corresponding reflections of the waveform signal at the physical receiving array and at the virtual receiving array;
compute deviations in response between the physical receiving array and the virtual receiving array;
assess effective positions of the first transmitter and the second transmitter, based upon the computed deviations; and
determine setup calibrations needed for the multiple-input and multiple-output radar system in order to reduce the computed deviations.

Optionally, the MIMO radar system is configured to minimize an error between the overlapping physical and virtual receiving sub-apertures by employing a least square fit.

Optionally, the MIMO radar system is configured to assess frequency response of the virtual receiving array.

Optionally, in the MIMO radar system, the waveform signal includes a linear, frequency-modulated chirp.

Optionally, in the MIMO radar system, the computed deviations include waveform deviations.

According to a third aspect, there is provided a computer program product comprising a non-transitory computer-readable storage medium having computer-readable instructions stored thereon, the computer-readable instructions being executable by a computerized device comprising processing hardware to execute a method pursuant to the first aspect.

Embodiments of the present disclosure substantially eliminate or at least partially address the aforementioned problems in the prior art, without complicating a MIMO radar system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DIAGRAMS

Embodiments of the present disclosure will now be described, by way of example only, with reference to the following diagrams wherein:

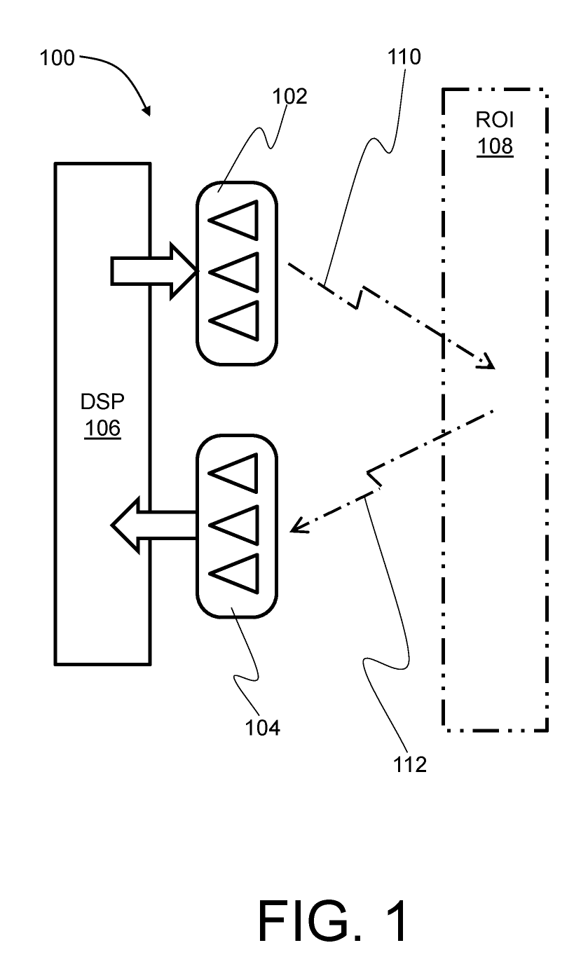

FIG. 1 is a schematic illustration of a MIMO radar system, in accordance with an embodiment of the present disclosure; and

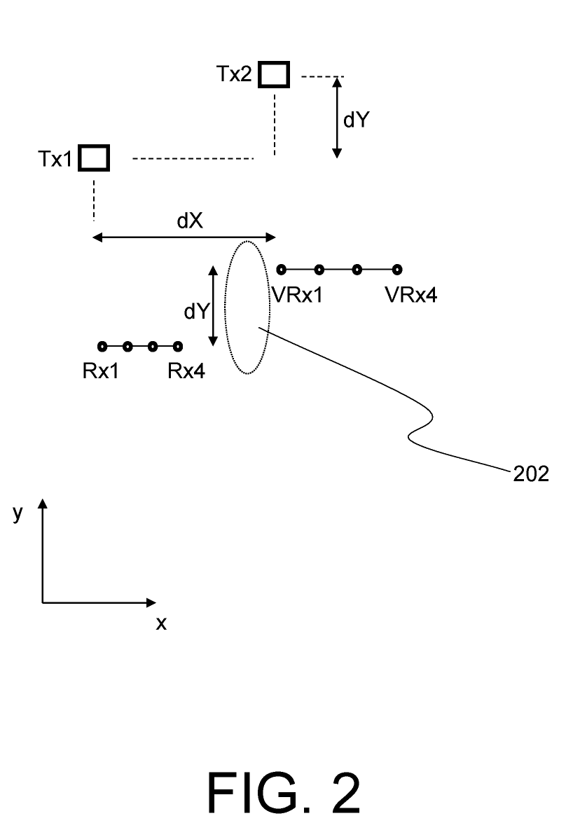

FIG. 2 is a schematic illustration of an example implementation of a transmitting array and a receiving array of a MIMO radar system, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

According to a first aspect, there is provided a method of calibrating a multiple-input and multiple-output radar system, wherein the radar system includes a transmitting array and a physical receiving array, the transmitting array including at least a first transmitter and a second transmitter that is spaced a distance away from the first transmitter, characterized in that the method includes:
(i) transmitting a waveform signal firstly from the first transmitter and then from the second transmitter such that receiving sub-apertures of the physical receiving array overlap with receiving sub-apertures of a virtual receiving array;
(ii) receiving corresponding reflections of the waveform signal at the physical receiving array and at the virtual receiving array;
(iii) computing deviations in response between the physical receiving array and the virtual receiving array;
(iv) assessing effective positions of the first transmitter and the second transmitter, based upon the computed deviations; and
(v) determining setup calibrations needed for the multiple-input and multiple-output radar system in order to reduce the computed deviations.

Optionally, the method is implemented as an iterative calibration in order to reduce the computed deviations. Such an iterative calibration is beneficial to employ when the radar system when operating in stochastically noisy environments.

Optionally, the method further includes minimizing an error between the overlapping physical and virtual receiving sub-apertures. More optionally, in the method, the minimizing the error includes employing a least square fit.

Optionally, in the method, the waveform signal employed includes a linear, frequency-modulated chirp.

Optionally, in the method, the waveform signal employed includes a step-wise frequency-modulated chirp.

Optionally, in the method, the transmitting the waveform signal includes transmitting the waveform signal at different time slots.

Optionally, in the method, the computing the deviations includes computing waveform deviations.

Optionally, the method further includes assessing frequency response of the virtual receiving array.

Optionally, the method is performed during manufacturing of the multiple-input multiple-output radar system.

Optionally, the method is performed during installation of the multiple-input multiple-output radar system.

According to a second aspect, there is provided a multiple-input and multiple-output radar system including a transmitting array, a physical receiving array and a signal processing arrangement, the transmitting array including at least a first transmitter and a second transmitter that is spaced a distance away from the first transmitter, characterized in that the radar system is configured to:
(i) transmit a waveform signal firstly from the first transmitter and then from the second transmitter such that receiving sub-apertures of the physical receiving array overlap with receiving sub-apertures of a virtual receiving array;
(ii) receive corresponding reflections of the waveform signal at the physical receiving array and at the virtual receiving array;
(iii) compute deviations in response between the physical receiving array and the virtual receiving array;
(iv) assess effective positions of the first transmitter and the second transmitter, based upon the computed deviations; and
(v) determine setup calibrations needed for the multiple-input and multiple-output radar system in order to reduce the computed deviations.

Optionally, the radar system is configured to implement in operation an iterative calibration in order to reduce the computed deviations.

Optionally, the radar system is configured to minimize an error between the overlapping physical and virtual receiving sub-apertures by employing a least square fit.

Optionally, when the radar system is in operation, the waveform signal includes a linear, frequency-modulated chirp.

Optionally, when the radar system is in operation, the waveform signal includes a step-wise frequency-modulated chirp.

Optionally, when the radar system is in operation, the computed deviations include waveform deviations.

Optionally, the radar system is configured to assess frequency response of the virtual receiving array.

In overview, embodiments of the present disclosure provide a method of calibrating a multiple-input and multiple-output (MIMO) radar system. The MIMO radar system includes a transmitting array and a physical receiving array, wherein the transmitting array includes at least a first transmitter and a second transmitter, wherein the second transmitter is spaced a distance away from the first transmitter. In the method, a waveform signal is transmitted firstly from the first transmitter and then from the second transmitter such that receiving sub-apertures of the physical receiving array overlap with receiving sub-apertures of a virtual receiving array. Corresponding reflections of the waveform signal are then received at the physical receiving array and at the virtual receiving array. A signal processing arrangement of the MIMO radar system then computes deviations in response between the physical receiving array and the virtual receiving array, and assesses effective positions of the first transmitter and the second transmitter, based upon the computed deviations. The signal processing arrangement also determines setup calibrations needed for the MIMO radar system in order to reduce the computed deviations. By employing the method, an improvement in technical performance of the MIMO radar system is achievable, for example a greater spatial resolution when interrogating its region of interest (ROI), an improved signal-to-noise ratio (SNR), and similar.

The method pursuant to embodiments of the present disclosure is suitable for performing during manufacturing and/or installation of the MIMO radar system. As an example, the MIMO radar system can be installed and used in many fields of application, for example:
(i) for on-vehicle radar-based systems, for example, such as automatic vehicle braking systems and automatic vehicle steering systems;
(ii) for monitoring safety-critical areas, for example, such as railway level-crossings;
(iii) for intruder alarm systems, for example, for detecting unauthorized personnel;
(iv) for airborne projectile guidance, for example, of high-velocity guided mortars;
(v) for obstacle detection in automated agricultural equipment, for example, such as automated combine harvesters, ploughing equipment, and automated fruit picking apparatus;
(vi) for use on harbour (harbor; US English) facilities, for example, for guiding automated equipment for handling ship containers; and so forth.

It will be appreciated that the aforementioned method can also be used for calibrating other systems, for example, such as radio communication systems, mobile telephone (namely “cell phone”) wireless communication systems, and so forth. Correspondingly, different types of transmitters and receivers can be used when employing the aforementioned method.

As an example, the method can be used to calibrate antenna arrays used in radio communication systems. It will be appreciated that, in the radio communication systems, even though calibrated antenna arrays are not important for supporting communication, they are needed to support certain features, for example, such as spatial positioning, GPRS and similar. Such spatial positioning, for example, is capable of enabling sources of interfering electromagnetic radiation to be avoided.

For illustration purposes only, embodiments of the present disclosure have been elucidated using examples of MIMO radar systems.

FIG. 1 is a schematic illustration of a MIMO radar system 100, in accordance with an embodiment of the present disclosure. The MIMO radar system 100 includes a transmitting array 102, a physical receiving array 104, and a signal processing arrangement (“digital signal processing”, DSP) 106.

With reference to FIG. 1, the MIMO radar system 100 is installed at a site or on a vehicle or projectile for monitoring a region of interest (ROI) 108.

The transmitting array 102 includes a plurality of transmitters for transmitting electromagnetic radar radiation towards the ROI 108. The physical receiving array 104 includes a plurality of receivers for receiving reflections of the transmitted electromagnetic radar radiation from the ROI 108.

In some implementations of embodiments of the present disclosure, at least one of the plurality of transmitters and at least one of the plurality of receivers are implemented by way of a transceiver that is capable of both transmitting and receiving electromagnetic radar radiations. Optionally, two of more of the plurality of transmitters and the plurality of receivers are implemented by way of a transceiver that is capable of both transmitting and receiving electromagnetic radar radiations; for example, optionally, all of the plurality of transmitters and the plurality of receivers are implemented by way of a transceiver that is capable of both transmitting and receiving electromagnetic radar radiations.

The signal processing arrangement (“digital signal processing”, DSP) 106 is operable to drive the transmitting array 102 to transmit a waveform signal 110 firstly from a first transmitter of the transmitting array 102 and then from a second transmitter of the transmitting array 102, namely at different time slots, such that receiving sub-apertures of the physical receiving array 104 overlap with receiving sub-apertures of a virtual receiving array. Alternatively, or additionally, the waveform signal 110 is transmitted firstly from the second transmitter of the transmitting array 102, and then from the first transmitter of the transmitting array 102, namely at different time slots, such that receiving sub-apertures of the physical receiving array 104 overlap with receiving sub-apertures of a virtual receiving array. Such an alternative order of using the first and second transmitter assists to reduce further calibration errors of the MIMO radar system 100.

Optionally, the waveform 110 signal includes a linear, frequency-modulated chirp. Alternatively, a pre-determined stepwise chirp, a pseudo-random stepwise chirp or an adaptive stepwise chirp is employed. The adaptive stepwise chirp is employed when the method is to be repeated for iterative improving performance of the MIMO radar system 100, for example to achieve a highly calibrated degree of performance. Such an iterative implementation of the method is of benefit when the MIMO radar system 100 is employed in a noisy environment, namely experience radar interference and other stochastic operative uncertainties, when a high degree of calibration accuracy of the MIMO radar system 100 is desired.

Corresponding reflections 112 of the waveform signal 110 are received at the physical receiving array 104 and at the virtual receiving array.

The signal processing arrangement (“digital signal processing”, DSP) 106 is then operable to compute deviations in response between the physical receiving array 104 and the virtual receiving array, namely between corresponding receiving sub-apertures of the physical receiving array 104 and the virtual receiving array. Optionally, in this regard, the signal processing arrangement (“digital signal processing”, DSP) 106 is then operable to compute waveform deviations in response between the corresponding receiving sub-apertures of the physical receiving array 104 and the virtual receiving array. When the aforementioned adaptive stepwise chirp is employed, for each iteration, a selection of stepwise frequency changes in the chirp is made to address particular operating conditions or radar interrogating polar directions that need especial attention for improving performance (namely improved polar beam-forming characteristics associated with the MIMO radar system 100).

The signal processing arrangement (“digital signal processing”, DSP) 106 is then operable to assess effective positions of the first transmitter and the second transmitter, based upon the computed deviations.

Additionally, optionally, the signal processing arrangement (“digital signal processing”, DSP) 106 is operable to assess frequency response of the virtual receiving array.

The signal processing arrangement (“digital signal processing”, DSP) 106 is then operable to determine setup calibrations needed for the MIMO radar system 100 in order to reduce the computed deviations. As aforementioned, the setup calibrations needed for the MIMO radar system 100 are adjusted iteratively, by repeating the method, so as to obtain a greater accuracy of calibration.

Optionally, the signal processing arrangement (“digital signal processing”, DSP) 106 is operable to reduce, for example to minimize, an error between the overlapping physical and virtual receiving sub-apertures. Optionally, when reducing, for example minimizing, the error, the signal processing arrangement (“digital signal processing”, DSP) 106 is operable to employ a least square fit.

Optionally, the signal processing arrangement (“digital signal processing”, DSP) 106 is implemented using one or more reduced instruction set computer (RISC) processors of a digital signal processing (DSP) apparatus. Optionally, the signal processing arrangement (“digital signal processing”, DSP) 106 includes computing hardware and is operable to execute one or more software products to control its operation.

Optionally, the MIMO radar system 100 is operable to generate the electromagnetic radar radiation in a frequency range of 10 GHz to 200 GHz. More optionally, the MIMO radar system 100 is operable to generate the electromagnetic radar radiation in a frequency range of 15 GHz to 150 GHz. Yet more optionally, the MIMO radar system 100 is operable to generate the electromagnetic radar radiation at a frequency of substantially 77 GHz.

FIG. 1 is merely an example, which should not unduly limit the scope of the claims herein. A person skilled in the art will recognize many variations, alternatives, and modifications of embodiments of the present disclosure.

FIG. 2 is a schematic illustration of an example implementation of a transmitting array and a receiving array of a MIMO radar system, in accordance with an embodiment of the present disclosure.

In FIG. 2, there are shown a first transmitter and a second transmitter of the transmitting array, denoted by Tx1 and Tx2, respectively. There are also shown receiving sub-apertures of a physical receiving array and a virtual receiving array, denoted by Rx1 to Rx4 and VRx1 to VRx4, respectively.

Phase centres of the first and second transmitters are spaced at a distance of dX and dY along a Cartesian x-axis direction and a Cartesian y-axis direction, respectively. Consequently, the receiving sub-apertures of the physical receiving array and the virtual receiving array are also spaced at a distance of dX and dY along the Cartesian x-axis direction and the Cartesian y-axis direction, respectively.

In FIG. 2, there is also shown an overlap 202 between the receiving sub-apertures of the physical receiving array and the virtual receiving array.

It will be appreciated that several overlapping sub-apertures can be employed in the MIMO radar system, and the number of overlapping sub-apertures is not limited to a particular number.

FIG. 2 is merely an example, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of calibrating a multiple-input and multiple-output radar system (100), wherein the radar system (100) includes a transmitting array (102) and a physical receiving array (104), the transmitting array (102) including at least a first transmitter and a second transmitter that is spaced a distance away from the first transmitter, wherein the method includes:
transmitting a waveform signal (110) firstly from the first transmitter and then from the second transmitter such that receiving sub-apertures of the physical receiving array (104) overlap with receiving sub-apertures of a virtual receiving array;
receiving corresponding reflections (112) of the waveform signal (110) at the physical receiving array (104) and at the virtual receiving array;
computing deviations in response between the physical receiving array (104) and the virtual receiving array;
assessing effective positions of the first transmitter and the second transmitter, based upon the computed deviations; and
determining setup calibrations needed for the multiple-input and multiple-output radar system (100) in order to reduce the computed deviations.

2. The method as claimed in claim 2, wherein the method is implemented as an iterative calibration in order to reduce the computed deviations.

3. The method as claimed in claim 1, wherein the method further includes minimizing an error between the overlapping physical and virtual receiving sub-apertures.

4. The method as claimed in claim 3, wherein the minimizing the error includes employing a least square fit.

5. The method as claimed in claim 1, wherein the waveform signal (110) includes a linear, frequency-modulated chirp.

6. The method as claimed in claim 1, wherein the waveform signal (110) includes a step-wise frequency-modulated chirp.

7. The method as claimed in claim 1, wherein transmitting the waveform signal (110) includes transmitting the waveform signal (110) at different time slots.

8. The method as claimed in claim 1, wherein computing the deviations includes computing waveform deviations.

9. The method as claimed in claim 1, wherein the method further includes assessing frequency response of the virtual receiving array.

10. The method as claimed in any one of the preceding claim 1, wherein the method is performed during manufacturing of the multiple-input multiple-output radar system (100).

11. The method as claimed in claim 1, wherein the method is performed during installation of the multiple-input multiple-output radar system (100).

12. A multiple-input and multiple-output radar system (100) including a transmitting array (102), a physical receiving array (104) and a signal processing arrangement (106), the transmitting array (102) including at least a first transmitter and a second transmitter that is spaced a distance away from the first transmitter, wherein the radar system (100) is configured to:
transmit a waveform signal (110) first from the first transmitter and then from the second transmitter such that receiving sub-apertures of the physical receiving array (104) overlap with receiving sub-apertures of a virtual receiving array;
receive corresponding reflections (112) of the waveform signal (110) at the physical receiving array (104) and at the virtual receiving array;
compute deviations in response between the physical receiving array (104) and the virtual receiving array;
assess effective positions of the first transmitter and the second transmitter, based upon the computed deviations; and
determine setup calibrations needed for the multiple-input and multiple-output radar system (100) in order to reduce the computed deviations.

13. The multiple-input and multiple-output radar system (100) as claimed in claim 12, wherein the radar system (100) is configured to implement in operation an iterative calibration in order to reduce the computed deviations.

14. The radar system (100) as claimed in claim 12, wherein the radar system (100) is configured to minimize an error between the overlapping physical and virtual receiving sub-apertures by employing a least square fit.

15. The radar system (100) as claimed in claim 12, wherein that the waveform signal (110) includes a linear, frequency-modulated chirp.

16. The radar system (100) as claimed in claim 12, wherein the waveform signal (110) includes a step-wise frequency-modulated chirp.

17. The radar system (100) as claimed in claim 12, characterized in that the computed deviations include waveform deviations.

18. The radar system (100) as claimed in claim 12, wherein the radar system (100) is configured to assess frequency response of the virtual receiving array.

19. A computer program product comprising a non-transitory computer-readable storage medium having computer-readable instructions stored thereon, the computer-readable instructions being executable by a computerized device comprising processing hardware to execute a method as claimed in claim 1.
